(19) United States
(12) Patent Application Publication
(10) Pub. No.: US 2008/0237995 A1
(43) Pub. Date: Oct. 2, 2008

(54) Mechanical Seal with Superior Thermal Performance

(75) Inventors: Michael M. Khonsari, Baton Rouge, LA (US); Ainsworth Gidden, Pearland, TX (US)

Correspondence Address: ADAMS AND REESE LLP, 4400 ONE HOUSTON CENTER, 1221 MCKINNEY, HOUSTON, TX, 77010, US

(73) Assignee: Louisiana State University, Baton Rouge, LA (US)

(21) Appl. No.: 11/693,986

(22) Filed: Mar. 30, 2007

(51) Int. Cl. F16J 15/38; F16J 15/02; F16J 15/34

(52) U.S. Cl. 277/390; 277/404; 277/637

(57) ABSTRACT

A stationary mating ring for a mechanical seal is provided, comprising an annular body having a central axis and a sealing face; a first circumferential groove formed into the body behind the sealing face; and a first annular fin extending radially from the central axis. The mating ring further may include a second circumferential groove formed in the body adjacent to the first circumferential groove, wherein the second circumferential groove defines a second annular fin extending radially from the central axis. Optionally, the first or second annular fins each include a plurality of subdivided fins extending radially from the central axis, and such fins are symmetrically spaced around the central axis. Also provided is a complete mechanical seal, comprising a rotating ring having a sliding interface against a mating ring constructed in accordance with the aforementioned features.

### STATEMENT REGARDING FEDERALLY SPONSORED RESEARCH

The U.S. Government has a paid-up license in this invention and the right in limited circumstances to require the patent owner to license others on reasonable terms as provided for by the terms of grant number DE-FG48-02R810707 awarded by the United States Department of Energy.

### BACKGROUND OF THE INVENTION

I. Field of the Invention

This invention relates to mechanical seals, e.g., single mechanical seals, double mechanical seals, tandem mechanical seals, bellows, pusher mechanical seals, and all types of rotating and reciprocating machines with reduced contact surface temperature, reduced contact surface wear, or increased life span, and more particularly to stationary mating rings for such mechanical seals.

II. Background and Prior Art

A mechanical seal is a device that inhibits leakage of a lubricant or a process fluid contained in a mechanical system. Mechanical seals typically comprise a primary ring (rotating ring) and a mating ring (stationary ring) having contact surfaces that slide against each other to form a seal between a rotating shaft and a mechanical housing structure. In most applications, the rotating ring is affixed to a rotary shaft, while the mating ring is installed in a gland, which is a device which holds the stationary ring in a cavity within the mechanical housing structure and connects it to a chamber surrounding the seal, that is adapted to abut the rotating ring. The rotating ring is typically pressed against the stationary ring either by a spring or a bellows system. Typically, an elastomer or a metallic component is used as a dynamic sealing element to minimize leakage between the rotating ring and the stationary ring by exerting a constant force against the rotating ring so that it stays in contact with the mating ring.

A common cause for failure of a mechanical seal is excessive wear, which often occurs when the mechanical seal becomes unbalanced. If the seal is unbalanced, spring pressure and fluid pressure may cause an increase in pressure between the contact surfaces of the rotating and mating rings, resulting in excessive wear and heat. Excessive heat and associated problems such as temperature and pressure gradients at the contact surface may lead to thermoelastic instability, causing hot spots on the contact surface of the mating ring, seal blistering, heat checking, and seal face cracking. These problems often result in excessive leakage and premature seal failure.

Another cause for failure of a mechanical seal is clogging, which can occur when micro-scale heat exchangers are used to cool the seal. Mechanical seals often operate in plant environments and are exposed to debris, and contamination such as rust, scale, and dirt in the cooling fluids (usually water and air) used to remove heat from the seal. Mechanical seal designs incorporating micro-scale heat exchangers are susceptible to clogging. As with other heat exchangers, contamination fouling becomes an important drawback in the effectiveness of heat transfer in mechanical seals, particularly those with an internal heat exchanger. The use of ultra-fine filters for blocking dirt influx is often not an acceptable solution, because of the tendency of the filter itself to clog and the high maintenance costs associated with monitoring and replacing filters. The increase in the pressure gradient across the filter may further contribute to power loss.

Mechanical seal designs incorporating micro-scale heat exchangers such as micro-sized fins and posts are also susceptible to premature failure caused by various loads such as torque and compression. For example, if the height or edge-to-edge spacing between adjacent micro-sized cooling fins or posts is too high, a sharp increase in torque, particularly at start-up when the coefficient of friction between the mating ring and rotating ring is at its highest value, could break the cooling fins and posts.

U.S. Pat. Application No. 2004/0026871A1 describes a device for providing heat transfer in bearings, seals, and other devices comprising a seal ring having a micro heat exchanger, a gland plate for securing the seal ring to a machinery housing (e.g., a pump housing), a heat sink cover plate, and a backing ring. In one embodiment, the gland plate comprises a first cooling fluid port in communication with the micro heat exchanger, an annular groove, and a group of cooling fluid distribution and collection ports in communication with the annular groove and the micro heat exchanger. The heat exchanger comprises a plurality of cooling fins attached to the heat sink cover plate, wherein each of the plurality of cooling fins has a cross-sectional dimension of between about 10-1000 microns, and an edge-to-edge spacing between adjacent cooling fins of about 100-1000 microns. The plurality of cooling fins may have a cross-section shape selected from the group consisting of round, elliptical, polygonal, triangular, rectangular, square, hexagonal, star-shaped, pentagonal, trapezoidal, octagonal and mixtures thereof.

Japanese Patent Abstract Publication No. 2003074713 describes a device for reducing the sliding heat of a mechanical seal, comprising a seal ring and a seal face by passing a fluid between a shaft and the seal ring to the inner peripheral side of the seal face.

U.S. Pat. Nos. 6,149,160 and 6,280,090 describe a device and method for improving heat transfer capability and lubricant flow of mechanical bearings and seals (e.g., ball bearings, roller bearings, journal bearings, air bearings, magnetic bearings, single mechanical seals, double mechanical seals, tandem mechanical seals, pusher mechanical seals, and bellows). The load-bearing surfaces of the bearings and seals are covered with large fields of high aspect ratio microstructures, such as microchannels or microposts.

U.S. Pat. No. 4,365,815 describes a device and method for cooling the working face of mechanical working elements such as bearings, rotary seals, and friction devices comprising two sealing members, each having a sealing face, mounted on a rotatable shaft, wherein at least one of the sealing members has a cavity with interconnecting pores that receive a cooling fluid to remove heat generated between the sealing faces.

U.S. Pat. No. 5,593,165 describes a device for providing heat transfer in seal systems for gas turbine engines comprising a mechanical housing, a shaft rotatably mounted within the housing, a first sealing element coupled to the housing, and a second sealing element connected to the shaft, wherein the second sealing element is arranged adjacent to the first sealing element to form a rubbing interface there-between. The second sealing element additionally comprises a channel on the radially inward side for receiving cooling fluid and allowing the fluid to escape at a plurality of points along its length. The shaft additionally comprises a passageway for delivering cooling fluid to the channel for cooling the second sealing element.

Japanese Patent Abstract Publication No. 60037462 describes a device and method to improve the cooling efficiency of a mechanical seal comprising an inner and outer fixed ring by passing cooling water through a passage between the fixed rings.

Japanese Patent Abstract Publication No. 59194171 describes a device and method to remove sliding heat generated in a mechanical seal comprising a casing and two sealing members by injecting a sealing liquid onto one the sealing members.

Japanese Patent Abstract Publication No. 58146770 describes a device and method to remove frictional heat generated in a mechanical seal comprising a first and a second sealing ring, each having a sealing face, a casing, and a heat pipe having a first end arranged near the vicinity of the first sealing ring, and a second end exposed in a chamber, by allowing frictional heat generated at the sealing end faces to be transmitted by the heat pipe from the first sealing ring to the chamber.

U.S. Pat. No. 4,123,069 describes a device for mechanically sealing a rotary shaft extending through stationary casings, comprising a rotatable ring fixed to the rotary shaft, a first stationary ring surrounding the rotary shaft and affixed to one of the casings, and a second stationary ring surrounding the rotary shaft and adapted to engage the rotatable ring. The rotatable ring comprises a plurality of radial passages for receiving a cooling medium to remove frictional heat generated between the rotatable ring and the second stationary ring.

U.S. Pat. No. 4,361,334 describes a stationary seal seat for reducing the operating temperature of a rotating mechanical seal comprising an annular ceramic ring insert disposed within a metal ring, and a glass coating between the ceramic insert and metal ring for fusing the two together. The ceramic insert additionally comprises an annular passage that extends around the insert at the interface between the insert and the metal ring, and ports which extend through the metal ring to allow coolant to flow between the ceramic insert and the metal ring.

U.S. Pat. No. 4,005,747 describes a heat exchanger and method for cooling a mechanical seal assembly affixed around a pump shaft. The heat exchanger comprises at least two cylindrical housing members having a plurality of grooves and slots surrounding the shaft to permit the flow of hot fluid from the pump to the heat exchanger, and cool fluid from the heat exchanger to flow back through the grooves and slots.

Also, U.S. Patent Application Publication No. 2006/0103073A1, co-authored by one of the co-inventors of the present application, describes a mechanical seal having a single-piece, perforated mating ring for controllably channeling coolant flow, the disclosure of which is incorporated herein by reference. In operation, a mechanical seal having this type of mating ring functions as an internal heat exchanger.

An unfilled need exists for mechanical seals, e.g., single mechanical seals, double mechanical seals, tandem mechanical seals, bellows, pusher mechanical seals, and all types of rotating and reciprocating machines, with reduced contact surface temperature, reduced contact surface wear, or increased life span. Moreover, an improved mechanical seal is needed which does not require a separate cooling loop or any modifications to the gland in order to retrofit the improved mechanical seal.

As the following description and claims will show, we have discovered a mechanical seal which satisfies a number of key objectives, including: (1) improved thermal performance, (2) cooperation with existing flash systems and plans, (3) retrofits requiring only a replacement of the mating ring, (4) no modifications to the gland, and (5) no separate cooling loop for removing heat at the interface between the rotating ring and the mating ring.

### SUMMARY OF THE INVENTION

Therefore, one object of the present invention is to provide a mechanical seal and mating ring which achieve superior thermal performance.

It is also an object of the present invention to provide a mechanical seal and mating ring which are suitable for use with known flash systems for conventional mechanical seals.

A further object of the present invention is to provide a mechanical seal and mating ring which enable a simple retrofit of the seal to be replaced without modifications to the gland.

Yet another object of the present invention is to provide a mechanical seal and mating ring which do not require a separate cooling loop.

Accordingly, a stationary mating ring for a mechanical seal is provided, comprising an annular body having a central axis and a sealing face; a first circumferential groove formed into the body behind the sealing face; and a first annular fin extending radially from the central axis. In a more preferred embodiment, the mating ring further includes a second circumferential groove formed in the body adjacent to the first circumferential groove, wherein the second circumferential groove defines a second annular fin extending radially from the central axis. Optionally, the first or second annular fins each include a plurality of subdivided fins extending radially from the central axis, and such fins are symmetrically spaced around the central axis. Preferably, the mating ring is coated with a layer of titanium-containing amorphous hydrocarbon or a diamond-like carbon (DLC) coating, and the mating ring can be fabricated from a number of materials, including cast iron, stainless steel, 17-4 PH stainless steel, Ni-resist, stellite, titanium alloys, ceramic (Al₂O₃), silicon carbide, silicon nitride, tungsten carbide, or graphite composites. Also provided is a complete mechanical seal, comprising a rotating ring having a sliding interface against a mating ring constructed in accordance with the aforementioned features.

### BRIEF DESCRIPTION OF THE DRAWINGS

FIG. 1 depicts a perspective view of a preferred embodiment of a mating ring in accordance with the present invention having a single annular fin.

FIG. 2 depicts a cross-sectional view of the mating ring of FIG. 1.

FIG. 3 depicts a sectional view of an alternative embodiment of the mating ring having at least two annular fins.

FIGS. 4A-4C depict another alternative embodiment in which one or more annular fins are further subdivided.

FIG. 5 depicts a cross-sectional view of a mechanical seal assembly having a mating ring in accordance with the present invention.

FIGS. 6A and 6B depict graphs illustrating the thermal performance of a conventional mating ring in comparison to the superior thermal performance of a preferred embodiment of a “fin” mating ring of the present invention.

### DETAILED DESCRIPTION OF THE PREFERRED EMBODIMENTS

With respect to the descriptions that follow, the objective of the invention was to design a mating ring that would provide improved thermal performance over an existing conventional ring design. An evaluation of the different factors that influence a mechanical seal performance was performed and designs were made based on these analyses. Key factors include: (a) the amount of surface area exposed to the coolant, (b) the width of the mating ring that forms the face area, (c) effective fins to improve the heat transfer, and (d) slots and grooves on the mating ring that takes advantage of the heat flow in the axial and radial directions to enhance heat transfer.

If the heat generated at the interface is controlled, then the life span of the mechanical seals can be extended. However, material properties influence the performance of a mechanical seal as it sets the coefficient of friction, which has a direct impact on the wear rate. If thermo-elastic instabilities are minimized, then the seal life is prolonged. If seals have a more uniform temperature profile, waviness and irregular wear profile are reduced. Also, if seals operate at a low surface temperature within the operating environment, its life expectancy would be longer.

Experimental tests conducted by others have shown that heat transfer for a mechanical seal takes place mostly in the axial and radial direction. The heat generated at the seal interface is dissipated by convection to the seal chamber coolant flow by the rotor and the stator. The largest magnitude of heat flux occurs on the rotor surface near the interface between the rotor and the stator. The thermo-elastic instabilities that build up in the mechanical seal during operation are caused by thermal stresses. Therefore, if the thermal stresses are reduced, then seal life can be prolonged. Thermo-elastic instabilities occur due to poor liquid lubrication, high speeds, high loads and if the seal material is prone to heat check. These instabilities form hot spots on some regions of the interface that developed a much higher temperature than the average causing some type of thermal damage. Hot spots expand relatively more than the adjacent material, thus causing a higher pressure to act on it, which results in more friction heating. All the heat leaving the seal is through convection with the coolant surrounding it in the stuffing box and conduction through the gland. Coolant fluid impacts the seal in two ways—one as a result of the process fluid, and the other through a flush port through the gland.

For a seal design to be successful the seal material should have the following properties: (a) wear resistance, (b) a low coefficient of thermal expansion, (c) have high overall strength, (d) good thermal properties, such as high thermal conductivity, to remove heat generated from the sliding surfaces, (e) good resistance to corrosion from both inside and outside environments, and (f) easy to manufacture and have low cost. The types of material used for the primary and mating ring in a seal assembly are usually different so that the resulting friction and wear is minimized. Therefore, the selection of material pairs should be made with the following considerations. First, a hard face and a soft face are often used, wherein the hardness difference is usually about twenty percent (20%). Second, a low friction coefficient between rotating material and stationary material is needed to decrease the heat generation at the interface and thus reduce thermal expansion. Finally, the two materials should have modulus of elasticity differences so that the stiffer material will be able to run into the softer one to make good sealing.

Additionally, one of the most important aspects of seal life is how the rings are cooled. Any design that improves the cooling characteristics of the primary and mating ring prolong the seal life. Mechanical seal cooling system can be a closed loop for the modified gland and an open loop for the conventional gland. The coolant, which is called the flush, is an external flush if it is taken from a source which is not the process fluid. However, if the flush is taken from the process fluid, it is called an internal flush. Whenever the flush flow is passed over the leakage side of the seal, it is called quenching. Quenching provides cooling by supplying a fluid of known temperature around the leakage side of the seal rings, and it washes away any foreign particles that may exist. The mating ring of the present invention is intended to be cooled by using an internal flush and used in conjunction with a conventional gland.

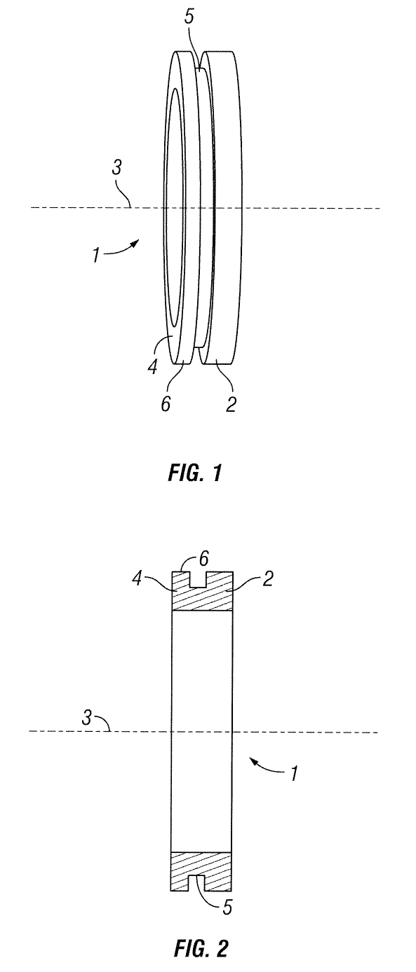

Turning now to FIG. 1, a preferred embodiment of a mating or stationary ring 1 for a mechanical seal is shown to comprise an annular body 2 having a central axis 3 and a sealing face 4. A first circumferential groove 5 is formed into the body 2 behind the sealing face 4, and at least one first annular fin 6 extends radially from the central axis 3. FIG. 2 depicts a cross-sectional view of the mating ring 1 which more clearly shows the locating of the first annular fin 6 and the first circumferential groove 5.

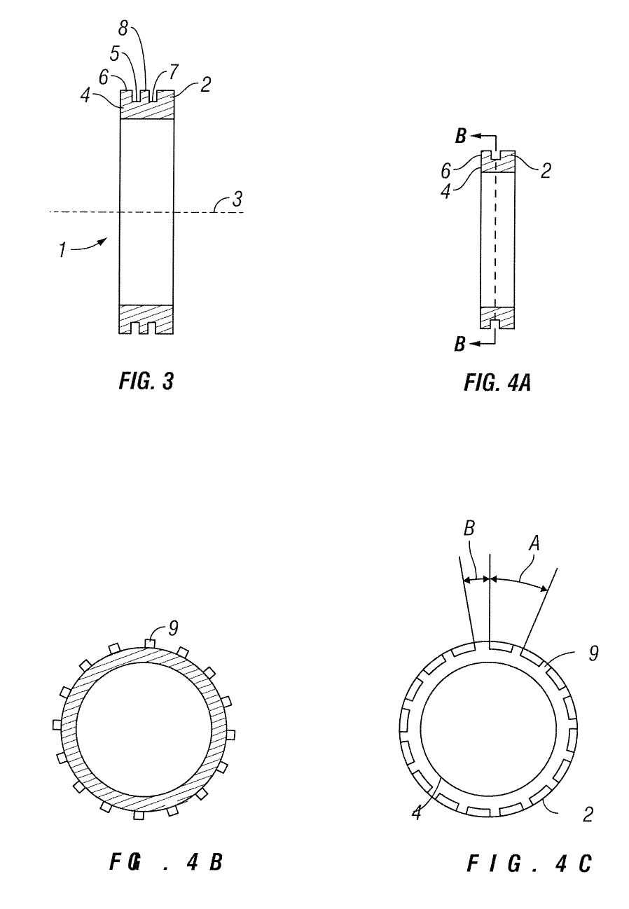

In an alternative embodiment shown in FIG. 3, the mating ring 1 further includes a second circumferential groove 7 formed in the body 2 adjacent to the first circumferential groove 5, wherein the second circumferential groove 5 defines at least one second annular fin 8 extending radially from the central axis 3. Optionally, and as shown in FIGS. 4A-4C, the first or second annular fins 6, 8, or both, each may include a plurality of subdivided fins 9 extending radially from the central axis, and such fins may be symmetrically spaced around the central axis 3. By way of example, and not intended as a limitation, the subdivided fins 9 may be spaced at an angle A from one another wherein each subdivided fin 9 occupies an angle B. Many combinations of slot spacing and fin widths can be used depending upon the specific thermal performance desired. If subdivided fins 9 are employed on both first and second annular fins 6, 8, such subdivided fins 9 on the first annular fin 6 may or may not be circumferentially offset from the subdivided fins 9 on the second annular fin 8. However, depending upon the manufacturing method chosen for fabrication of the mating ring 1, it may be more cost effective to manufacture the mating ring 1 such that the subdivided fins 9 on both first and second annular fins 6, 8 are aligned, and without significant difference in thermal dissipation.

Mating ring 1 is preferably constructed from 17-4-PH stainless steel, which is a precipitation hardening finish steel making the properties throughout the material more homogeneous. Although 17-4 PH stainless steel is preferred, the mating ring 1 can be fabricated from a number of alternative materials, including cast iron, Ni-resist, stellite, titanium alloys, ceramic (Al₂O₃), silicon carbide, silicon nitride, tungsten carbide, graphite composites, or other materials having suitable characteristics. Optionally, the mating ring 1 may also be coated with a layer of titanium-containing amorphous hydrocarbon or a diamond-like carbon (DLC) coating.

The mating ring 1 dimensions and holes are preferably established before heat treatment. Since hardness is an important characteristic in reducing the wear rate, the mating ring 1 may be heat treated to a Rockwell C hardness of 45. The sealing face 4 is then lapped to a surface finish between 1-2 helium light bands. One helium light band measures approximately 0.00012 inch (0.000304 m). It should be noted that the larger the diameter of mating ring 1, the higher the convective heat transfer area. Larger diameters also increase the conductive heat transfer resistance and causes a net reduction in the heat transfer efficiency. Most of the heat transfer takes place within a distance approximately two face widths from the sealing face 4 in the radial and axial direction and the mating ring 1. Because of the greater thermal conductivity of the mating ring 1 in comparison to the rotating ring, the mating ring 1 transfers the majority of the heat from the interface. With respect to the sealing face 4, the area of the sealing face 4 which is actually in contact with the rotating ring is kept to a minimum in order to reduce thermal resistance to conduction. The slots between subdivided fins 9 are preferably formed in areas which maximize the amount of heat transfer possible, and such subdivided fins 9 are dimensioned so as to impart the greatest surface area for improving the heat transfer characteristics of the mating ring 1.

With regard to the fins 9, the heat transfer rate is improved by increasing the surface area. However, for a fin to be useful, it should have an “effectiveness” greater than two. Effectiveness is a parameter that can serve as a guide in assessing whether installation of a fin (extended area) is justified from a manufacturing and economic perspective. The higher the effectiveness value, the better. This is usually the case when the system's convective heat transfer coefficient, h, is low, and by adding a fin, one obtains a greater value of effectiveness. To evaluate the effectiveness, an infinitely long fin approximation was used with

$${E}_{f} = {( \frac{{kp}_{A}}{{hA}_{C}} )}^{0.5} ,$$

where k is the conduction coefficient, p_{A} is the perimeter of the fin, h is the convection coefficient, and A_{C} is the cross sectional area. However, this equation does not represent a true approximation of the fins made for the fin mating ring 1. It provides a close approximation of the fins effectiveness. Fins are more effective in an environment when the convection coefficient is small. But, the smaller the cross-sectional area of the fins, the more effective would be the fin designs. Having fins 6, 8, or subdivided fins 9 on the mating ring 1 would improve its heat transfer capability, therefore reducing the heat at the interface and prolonging the seal life. Using the equations

$${Nu}_{stator} = 121.51 {{Pr}^{0.89} ( \frac{{Re}_{flush}}{{Re}_{ro}} )}^{0.56}$$

for the Nusselt number Nu, and

$${H}_{C} = \frac{{NuK}_{f}}{D}$$

for the convection coefficient, the approximate convection coefficient was calculated. The Nusselt number is a function of the Prandt1 number, Pr, and the Reynolds number Re. Calculations were done to optimize the cross-sectional area to give largest fin effectiveness possible with the manufacturing processes acting as a constraint. With the required dimensions for the fin calculated, the other concepts drawn from the theory were incorporated. The fin mating ring 1 would allow the coolant to move as close as possible to the contact interface and take advantage of the axial and radial heat transfer characteristics. The mating ring 1 would be able to be used in a conventional mating ring setup with no additional O-rings or parts. Therefore, the flush (coolant) should leave the sealing chamber by mixing with the process fluid, pass the pump wear rings, and into the pump scroll to the pump discharge.

For this design, emphasis had to be placed on the diameter on the mating ring 1 where the fins will start. It was important that enough face area exist so that the primary ring does not overlap during operation. This was critical especially at start-up, because the axial movement of the motor causes the primary ring to be slightly misaligned until it aligns itself. With this in mind, the diameter at which the fins 6, 8 or subdivided fins 9 start was larger than the diameter of the primary ring.

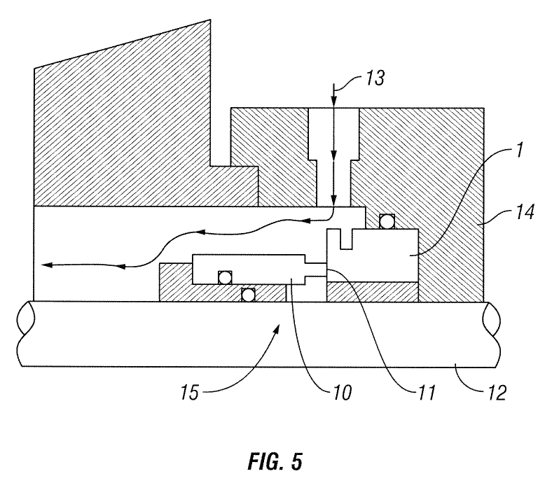

FIG. 5 depicts a mechanical seal assembly 15 which utilizes a mating ring 1 of the present invention, specifically the embodiment of FIGS. 1 and 2, comprising a rotating ring 10 having a sliding interface 11 against a mating ring 1. The rotating ring 10 is attached to a shaft 12 in the normal manner, and the mating ring 1 is secured within the gland 14. A coolant path 13 is directed over the interface 11 to remove heat from the mechanical seal assembly 15.

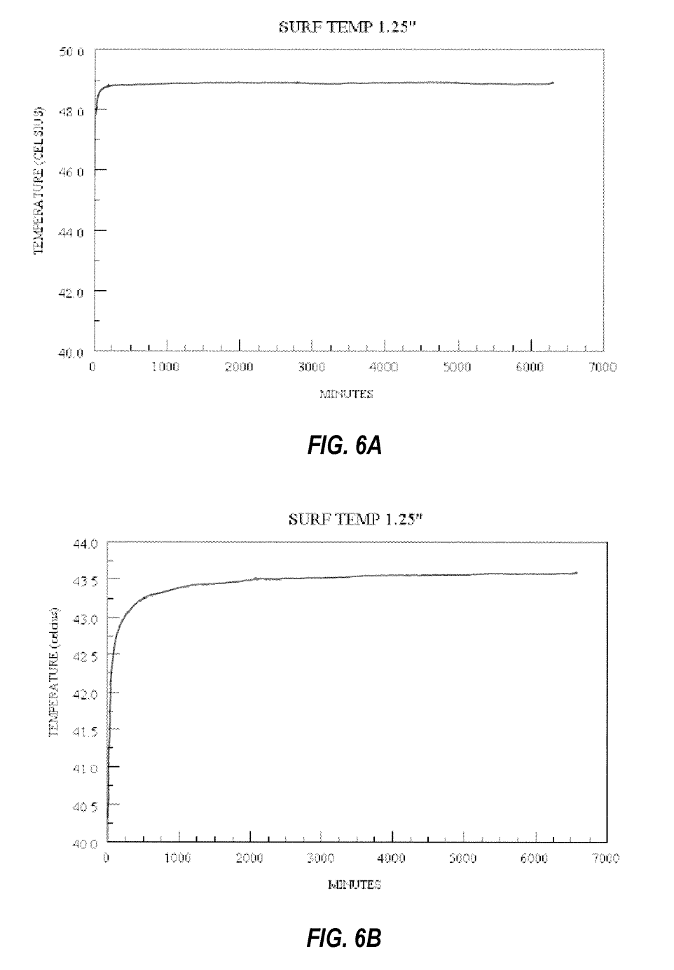

Finally, FIG. 6A depicts a graph illustrating the thermal performance of a conventional mating ring wherein the surface temperature reaches approximately 49° C. Under identical conditions, the superior thermal performance of the “fin” mating ring is shown in FIG. 6B wherein the surface temperature stabilizes at approximately 43.5° C. and rises more slowly from the start up conditions.

Although exemplary embodiments of the present invention have been shown and described, many changes, modifications, and substitutions may be made by one having ordinary skill in the art without necessarily departing from the spirit and scope of the invention.

We claim:

1. A stationary mating ring for a mechanical seal, comprising:
(a) an annular body having a central axis and a sealing face;
(b) a first circumferential groove formed into said body behind said sealing face; and
(c) a first annular fin extending radially from said central axis.

2. The mating ring of claim 1, further including a second circumferential groove formed in said body adjacent to said first circumferential groove, wherein said second circumferential groove defines a second annular fin extending radially from said central axis.

3. The mating ring of claim 2, wherein said first annular fin includes a plurality of subdivided fins extending radially from said central axis.

4. The mating ring of claim 2, wherein said second annular fin includes a plurality of subdivided fins extending radially from said central axis.

5. The mating ring of claim 1, wherein said first circumferential groove is formed in a plane perpendicular to said central axis.

6. The mating ring of claim 1, wherein said first annular fin includes a front face and a rear face, wherein said front face is coplanar with said sealing face, and wherein said rear face is defined by said first circumferential groove.

7. The mating ring of claim 3, wherein said subdivided fins are symmetrically spaced around said central axis.

8. The mating ring of claim 4, wherein said subdivided fins are symmetrically spaced around said central axis.

9. The mating ring of claim 1, wherein said mating ring is coated with a layer of titanium-containing amorphous hydrocarbon or diamond-like carbon (DLC) coating.

10. The mating ring of claim 1, wherein said mating ring is fabricated from a material selected from the group consisting of cast iron, stainless steel, 17-4 PH stainless steel, Ni-resist, stellite, titanium alloys, ceramic (Al₂O₃), silicon carbide, silicon nitride, tungsten carbide, and graphite composites.

11. A mechanical seal having a rotating seal ring and a stationary mating ring, wherein said seal ring and said mating ring cooperate to form a sealing interface, wherein heat is transferred from said sealing interface by a cooling fluid in contact with said seal ring and said mating ring, and wherein said mating ring comprises:
(a) an annular body having a central axis and a sealing face;
(b) a first circumferential groove formed into said body behind said sealing face; and
(c) a first annular fin extending radially from said central axis.

12. The mechanical seal of claim 11, further including a second circumferential groove formed in said body adjacent to said first circumferential groove, wherein said second circumferential groove defines a second annular fin extending radially from said central axis.

13. The mechanical seal of claim 12, wherein said first annular fin includes a plurality of subdivided fins extending radially from said central axis.

14. The mechanical seal of claim 12, wherein said second annular fin includes a plurality of subdivided fins extending radially from said central axis.

15. The mechanical seal of claim 11, wherein said first circumferential groove is formed in a plane perpendicular to said central axis.

16. The mechanical seal of claim 11, wherein said first annular fin includes a front face and a rear face, wherein said front face is coplanar with said sealing face, and wherein said rear face is defined by said first circumferential groove.

17. The mechanical seal of claim 13, wherein said subdivided fins are symmetrically spaced around said central axis.

18. The mechanical seal of claim 14, wherein said subdivided fins are symmetrically spaced around said central axis.

19. The mechanical seal of claim 11, wherein said mating ring is coated with a layer of titanium-containing amorphous hydrocarbon or diamond-like carbon (DLC) coating.

20. The mechanical seal of claim 1, wherein said mating ring is fabricated from a material selected from the group consisting of cast iron, stainless steel, 17-4 PH stainless steel, Ni-resist, stellite, titanium alloys, ceramic (Al₂O₃), silicon carbide, silicon nitride, tungsten carbide, and graphite composites.

21. The mechanical seal of claim 11, wherein said cooling fluid is selected from the group consisting of air, nitrogen, water, ethylene glycol, propane, and lubricating oil.
